(19) United States
(12) Patent Application Publication
(10) Pub. No.: US 2011/0293330 A1
(43) Pub. Date: Dec. 1, 2011

(54) IMAGE FORMING APPARATUS AND GAP MAINTAINING METHOD OF CHARGING ROLLER

(75) Inventors: Masashi Takahashi, Kanagawa-ken (JP); Takeshi Watanabe, Kanagawa-ken (JP); Daisuke Yamashita, Shizuoka-ken (JP); Shoko Shimmura, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/150,681

(22) Filed: Jun. 1, 2011

Related U.S. Application Data
(60) Provisional application No. 61/350,272, filed on Jun. 1, 2010.

(51) Int. Cl. G03G 15/02

(52) U.S. Cl. 399/168

(57) ABSTRACT

An image forming apparatus includes: a photoconductor that rotates about a first rotation axis; and a charging roller that rotates about a second rotation axis which is parallel to the first rotation axis, wherein the charging roller includes a conductive roller portion that extends in parallel with the first rotation axis and contains an ion-conductive agent, a flange portion that is provided on an outer peripheral surface of the conductive roller portion further to the outside than an image forming area of the photoconductor in the second rotation axis direction so as to protrude outward from the outer peripheral surface in the radial direction of the conductive roller portion into a flange shape, and an insulating elastic layer that coats the outer peripheral surface of the flange portion and has an elasticity higher than that of a photoconductive surface of the photoconductor.

### CROSS-REFERENCE TO RELATED APPLICATION(S)

This application is based upon and claims the benefit of priority from: U.S. provisional application 61/350272, filed on Jun. 1, 2010; the entire contents all of which are incorporated herein by reference.

### FIELD

Exemplary embodiments described herein relate to a technique for charging a photoconductive surface of a photoconductor by a non-contact charge.

### BACKGROUND

In the related art, a non-contact charging technique is known of charging a photoconductive surface of a photoconductor using a charging roller which is not in contact with the photoconductive surface.

In the non-contact charging technique according to the related art, in order to maintain a gap between the charging roller and the photoconductor, a roller made of a hard resin, a metal bearing, or the like is provided in the charging roller.

When the roller made of the hard resin is used, a general-purpose resin such as polyethylene (PE) polypropylene (PP), polyacetal (POM), poly(methyl methacrylate) (PMMA), polystyrene (PS), or a copolymer (AS or ABS) thereof, or a resin material such as polycarbonate (PC), urethane, or fluorine (PTFE) is molded into a roller shape by molding. Here, in order to maintain precision of the gap between the charging roller and the photoconductor, a process such as cutting or polishing needs to be performed on the roll.

Besides, a configuration in which a tube is coated or a tape is wound in the vicinities of both ends of the outer peripheral surface of the charging roller may be considered. However, in order to maintain the precision of the gap between the charging roller and the photoconductor, a hard material has to be selected in the end.

As such, since the material for maintaining the precision of the gap between the charging roller and the photoconductor is a hard material, deterioration such as blowholes or peeling of a film is more likely to occur on the surface layer of the photoconductor.

### DESCRIPTION OF THE DRAWINGS

FIG. 1 is a longitudinal cross-sectional view showing a simplified configuration of the overall image forming apparatus.

FIG. 2 is a schematic diagram showing a relationship between a charging roller and a photoconductor.

FIG. 3 is a cross-sectional view showing a configuration of the charging roller.

FIG. 4 is a diagram showing the result of an endurance test that evaluates damage in the photoconductor.

FIG. 5 is a surface enlarged photograph showing a photoconductive surface of the photoconductor which is not damaged.

FIG. 6 is a surface enlarged photograph showing the deteriorated photoconductive surface where carrier flaws or holes are present.

FIG. 7 is a diagram showing the cross-section of a charging roller related to a modified example.

FIG. 8 is a table showing the test result of an endurance test when the thickness of a fluorine surface layer is changed.

FIG. 9 is an enlarged photograph of the surface of the photoconductor under a condition in which no problem is determined when the evaluation test is performed using the charging roller having the configuration shown in FIG. 7.

### DETAILED DESCRIPTION

In general, according to an embodiment, an image forming apparatus includes a photoconductor and a charging roller. The photoconductor rotates about a first rotation axis. The charging roller rotates about a second rotation axis which is parallel to the first rotation axis. In addition, the charging roller includes a conductive roller portion that extends in parallel with the first rotation axis and contains an ion-conductive agent, a flange portion that is provided on the outer peripheral surface of the conductive roller portion further to the outside than an image forming area of the photoconductor in the second rotation axis direction so as to protrude outward from the outer peripheral surface in a radial direction of the conductive roller portion into a flange shape, and an insulating elastic layer that coats an outer peripheral surface of the flange portion and has an elasticity higher than that of the photoconductive surface of the photoconductor.

Hereinafter, embodiments will be described with reference to the accompanying drawings.

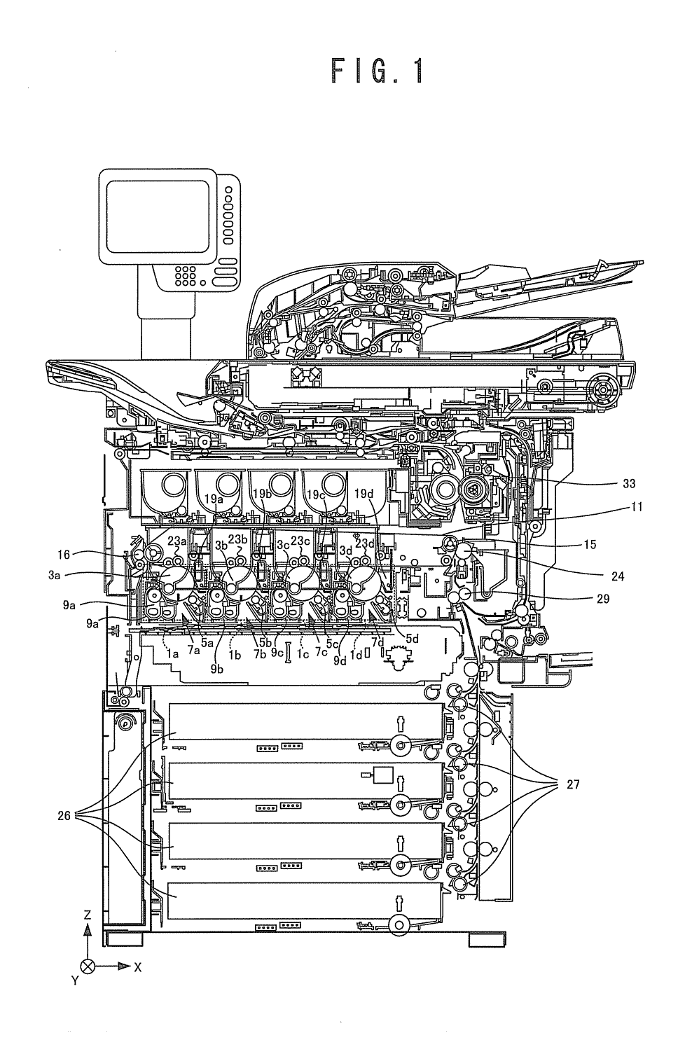

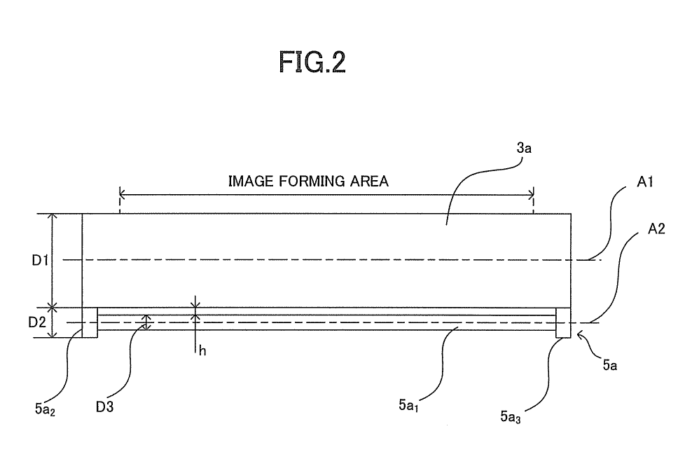

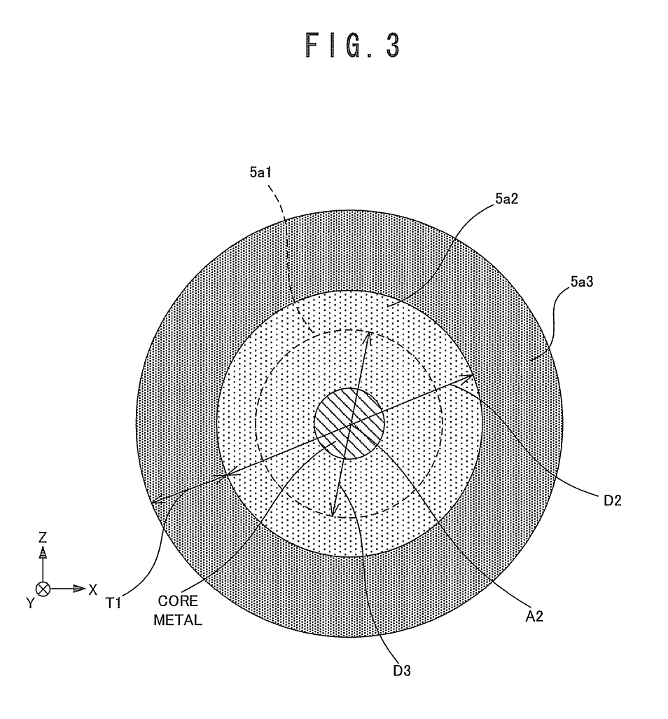

FIG. 1 is a longitudinal cross-sectional view showing a simplified configuration of the overall image forming apparatus. FIG. 2 is a schematic diagram showing a relationship between a charging roller 5a and a photoconductor. FIG. 3 is a cross-sectional view showing a configuration of the charging roller 5a.

The image forming apparatus shown in FIG. 1 employs electrophotography in which a toner image is formed on the surface of a photoconductor charged by a non-contact charging method.

Here, as an example, a tandem-type color image forming apparatus in which a plurality of photoconductors is arranged in a straight line is described. However, the embodiment is not limited thereto, and for example, a monochrome image forming apparatus, or a revolver-type color image forming apparatus in which a plurality of developing devices is arranged in the periphery of a single photoconductor may also be employed.

As shown in FIG. 1, the image forming apparatus according to this embodiment includes process units 1a, 1b, 1c, and 1d as image forming units.

The process units respectively have photoconductive drums 3a, 3b, 3c, and 3d (photoconductors) which are image holding members and form developer images on the photoconductive surfaces of the photoconductive drums.

As an example, the process unit 1a will be described.

Specifically, the process unit 1a includes a photoconductive drum 3a, a charging roller 5a, an exposure device 7a, a developing device 9a, and a cleaner 19a.

In FIG. 1, the photoconductive drum 3a has a cylindrical shape with a diameter of 30 mm and is provided to be rotatable about a rotation axis A1 as a rotation center axis (first rotation axis).

In the periphery of the photoconductive drum 3a, the following is disposed along the rotation direction. First, the charging roller 5a is provided to oppose the surface of the photoconductive drum 3a. The charging roller 5a uniformly negatively (−) charges the photoconductive drum 3a.

On the downstream side of the charging roller 5a, the exposure device 7a which exposes the charged photoconductive drum 3a and forms an electrostatic latent image is provided.

On the downstream side of the exposure device 7a, the developing device 9a is provided which stores a yellow developer and reversely develops the electrostatic latent image formed by the exposure device 7a using this developer.

In addition, an intermediate transfer belt 11 which is a medium in which an image is formed is installed so as to abut on the photoconductive drum 3a.

On the downstream side of the abutting position of the photoconductive drum 3a and the intermediate transfer belt 11, the cleaner 19a is provided. The cleaner 19a neutralizes surface charges of the photoconductive drum 3a after a transferring operation by uniform light illumination and removes and stores residual toner on the photoconductor. Accordingly, one cycle of image formation is completed, and in a subsequent image forming process, the charging roller 5a uniformly charges the uncharged photoconductive drum 3a again.

The intermediate transfer belt 11 has substantially the same length (width) as that of the photoconductive drum 3a in a direction (the depth direction of the figure) parallel to the rotation axis A1 (see FIG. 2) of the photoconductive drum 3a. The intermediate transfer belt 11 has a shape of an endless (seamless) belt and is suspended on a driving roller 15 that turns the belt at a predetermined speed and several driven rollers.

At least a part of the intermediate transfer belt 11 is formed of polyimide in which carbon is uniformly dispersed and which has a thickness of 100 m. The belt has an electrical resistivity of 10⁹ Ω·cm and has semi-conductive properties.

Specifically, as the belt material of the intermediate transfer belt 11, a material which has a volume resistivity of 10⁸ to 10¹¹ Ω·cm and exhibits semi-conductive properties may be employed.

For example, as the belt material of the intermediate transfer belt 11, as well as polyimide in which carbon is dispersed, a material in which conductive particles such as carbon are dispersed in polyethylene terephthalate, polycarbonate, polytetrafluoroethylene, polyvinylidene fluoride, or the like may be employed. Without the use of conductive particles, a polymer film of which the electrical resistivity is adjusted by composition adjustment may be used. Moreover, a material in which an ion-conductive material is incorporated into the polymer film, or a rubber material such as silicone rubber or urethane rubber having a relatively low electrical resistivity may also be used.

On the intermediate transfer belt 11, between the driving roller 15 and a secondary transfer opposing roller 24 in the movement direction of the belt surface of the intermediate transfer belt 11, the process units 1b, 1c, and 1d as well as the process unit 1a are arranged.

The process units 1b, 1c, and 1d all have the same configuration as that of the process unit 1a. That is, the photoconductive drums 3b, 3c, and 3d are provided substantially at the center of the respective process units 1b, 1c, and 1d. In the peripheries of the photoconductive drums, the charging rollers 5b, 5c, and 5d are respectively provided. On the downstream sides of the charging rollers, the exposure devices 7b, 7c, and 7d are provided. The configuration in which the developing devices 9b, 9c, and 9d and the cleaners 19b, 19c, and 19d are provided on the downstream sides of the exposure devices is the same as that of the process unit 1a, the difference being developers stored in the developing devices. The developing device 9b stores a magenta developer, the developing device 9c stores a cyan developer, and the developing device 9d stores a black developer.

The intermediate transfer belt 11 sequentially abuts on the photoconductive drums.

In the vicinities of the abutting positions of the intermediate transfer belt 11 and the photoconductive drums, transferring devices 23a, 23b, 23c, and 23d as transferring units are provided to correspond to the respective photoconductive drums. That is, the transferring device 23 is provided to come in contact with the rear surface of the intermediate transfer belt 11 above the corresponding photoconductive drum and opposes the process unit via the intermediate transfer belt 11.

The transferring device 23a is connected to a positive (+) DC power supply 25a (not shown) which is a voltage applying unit. Similarly, the transferring devices 23b, 23c, and 23d are respectively connected to DC power supplies 25b, 25c, and 25d (not shown).

Below the image forming units, paper feed cassettes 26 that store sheets are provided in a plurality of stages. In the main body of the image forming apparatus, a pick-up roller 27 is provided which picks up sheets from the paper feed cassettes 26 one by one. In the vicinity of a secondary transfer roller, a pair of registration rollers 29 is provided to be rotatable. The pair of registration rollers 29 supplies a sheet to a secondary transfer portion which is a nip formed by the intermediate transfer belt 11 and the secondary transfer opposing roller 24 at a predetermined timing.

In addition, in FIG. 1, on the downstream side from the secondary transfer portion in a sheet transport direction, a fixing device 33 that fixes the developer onto the sheet and a paper discharge tray to which the sheet fixed by the fixing device 33 is discharged are provided.

Subsequently, a color image forming operation of the image forming apparatus configured as described above will be described.

When the start of image formation is instructed, the photoconductive drum 3a receives a driving force from a driving mechanism (not shown) and starts rotating. The charging roller 5a uniformly charges the photoconductive drum 3a to about −600 V. The exposure device 7a irradiates the photoconductive drum 3a which is uniformly charged by the charging roller 5a with light according to an image to be recorded so as to form an electrostatic latent image. The developing device 9a stores the developer (a two-component developer made by mixing yellow (Y) toner with a ferrite carrier) and applies a bias value of −380 V to a developing sleeve (not shown) using a developing bias supply (not shown) so as to form a developing electric field between the developing device 9a and the photoconductive drum 3a. The yellow toner negatively charged is adhered to an area of an image portion potential of the electrostatic latent image of the photoconductor 3a (reversal development).

Next, the developing device 9b develops the electrostatic latent image using the magenta developer, and forms a magenta toner image on the photoconductive drum 3b. This magenta toner has the same volume average particle diameter of 7 μm as that of the yellow toner, and is negatively charged by a charge by friction with ferrite magnetic carrier particles (not shown) having a volume average particle diameter of about 50 μm. The average charging amount is about −30 μC/g. The developing bias value is about −380 V similarly to the developing device 9a, and is applied to the developing sleeve (the structure of the developing device is the same as that of the developing device 9a) by the bias supply (not shown). The direction of the developing electric field is directed to the developing sleeve from the surface of the photoconductive drum 3b at the image portion, and the negatively charged magenta toner is adhered to the latent image potential portion.

At a transfer area formed by the photoconductive drum 3a, the intermediate transfer belt 11, and the transferring device 23a, a bias voltage of about +1,000 V is applied by the transferring device 23a. A transfer electric field is formed between the transferring device 23a and the photoconductive drum 3a, and the yellow toner image on the photoconductive drum 3a is transferred onto the intermediate transfer belt 11 by the transfer electric field.

The transferring device will be described in more detail.

The transferring device 23a is a conductive urethane foam roller which has conductive properties since carbon is dispersed therein. The roller having a core metal of φ10 mm and an outside diameter of φ18 mm is formed. The electrical resistance between the core metal and the roller surface is about 10⁶ Ω. The constant-voltage DC power supply 25a is connected to the core metal.

A power supply device in the transferring device is not limited to the roller, and a conductive brush, a conductive rubber blade, a conductive sheet, or the like may be employed. The conductive sheet may be made of, as a rubber material or resin film in which carbon is dispersed, a rubber material such as silicone rubber, urethane rubber, or EPDM, or a resin material such as polycarbonate. It is preferable that the volume resistivity thereof range from 10⁵ to 10⁷ Ω·cm.

At both ends of a roller shaft, springs are provided as urging units, such that the transferring device 23a is urged to elastically abut on the intermediate transfer belt 11 by the springs in the vertical direction. The magnitude of the urging force by the springs provided in each transferring device is set to 600 gft. Here, the urging force is the sum of urging forces of the springs disposed at both ends of the roller shaft.

The configurations of the transferring devices 23b, 23c, and 23d are the same as that of the transferring device 23a, and the transferring devices are the same as in the configuration that elastically abuts on the intermediate transfer belt 11, so that description of the configurations of the transferring devices 23b, 23c, and 23d will be omitted.

The image on the intermediate transfer belt 11 to which the yellow toner image is transferred in the transfer area is transported to a magenta transfer area. In the transfer area, the magenta toner image is transferred onto the yellow toner image so as to be overlapped therewith by applying a bias voltage of about +1,200 V from the DC power supply to the transferring device 23b.

In a cyan transfer area, a bias voltage of about +1,400 V is applied to the transferring device 23c, and in a black transfer area, a voltage of about +1,600 V is applied to the transferring device 23d, such that a cyan developer image and a black developer image are sequentially transferred onto the developer image that is already transferred so as to be overlapped therewith.

On the other hand, the pick-up roller 27 takes out sheets from the paper feed cassette 26, and the pair of registration rollers 29 supplies the sheet P to the secondary transfer portion.

At the secondary transfer portion, a predetermined bias is applied to the secondary transfer opposing roller 24, a transfer electric field is formed between the secondary transfer opposing roller and the secondary transfer roller via the belt, and the multiple-color toner image on the intermediate transfer belt 11 is collectively transferred onto the sheet P.

The developer images for the respective colors that are collectively transferred as described above are fixed onto the sheet P by the fixing device 33, thereby forming a color image. The sheet P after being fixed is discharged to the paper discharge tray.

Subsequently, the detailed configuration of the charging roller will be described with reference to FIGS. 2 and 3. Here, as an example, the charging roller 5a is described. The charging rollers 5b to 5d have the same configuration as that of the charging roller 5a.

The charging roller 5a includes a conductive roller portion 5a1, a flange portion 5a2, and an insulating elastic layer 5a3.

The conductive roller portion 5a1 is a charging roller which rotates about a second rotation axis A2 (core metal) that is parallel to the first rotation axis A1. The conductive roller portion 5a1 has a roller shape extending in parallel to the first rotation axis A1 and is made of a conductive resin containing an ion-conductive agent.

The flange portion 5a2 is provided on the outer peripheral surface of the conductive roller portion 5a1 on the outside from the image forming area of the photoconductive drum 3a in the second rotation axis A2 direction so as to protrude outward from the outer peripheral surface in the radial direction of the conductive roller portion 5a1 into a flange shape (see FIG. 3).

The insulating elastic layer 5a3 acts as a surface layer that coats the outer peripheral surface of the flange portion 5a2 and is formed of a material having an elasticity higher than that of the photoconductive surface of the photoconductive drum 3a. The insulating elastic layer 5a3 may be, for example, an insulating rubber layer.

In addition, the flange portions 5a2 may be provided on both ends of the conductive roller portion 5a1 in the second rotation axis A2 direction. Accordingly, while avoiding contact with the image forming area of the photoconductor, the gap and parallelism between the roller surface of the conductive roller portion 5a1 and the photoconductive surface can be maintained at a high precision.

In addition, the diameter D2 of the flange portion 5a2 is greater than the diameter D3 of the conductive roller portion 5a1 (see FIG. 3).

In a non-contact charging roller according to the related art, charging can be made with a gap of only about 10 μm to 50 μm. However, as the conductive roller portion 5a1 is made of a resin roller in which the ion-conductive agent is dispersed, charging can be made with a distance (gap) from the photoconductive surface in the range of about 50 μm to 300 μm.

As such, since the gap between the roller surface of the conductive roller portion 5a1 and the photoconductive surface is widened, adhesion of stains to the roller surface can be suppressed. Particularly, even though the carrier contained in the two-component developer is adhered to the surface of the photoconductor, since the carrier passes through the gap, deterioration of the surface of the photoconductor (generation of holes or flaws) can be suppressed.

As such, in this embodiment, a charging method in which a gap between the roller surface of the conductive roller portion 5a1 and the photoconductive surface, which is wider than that according to the related art, is employed. Specifically, as a DC voltage or a voltage made by overlapping a DC voltage with an AC voltage is applied to the core metal A2 of the charging roller 5a, a proximity discharge is generated in a space between the roller surface of the conductive roller portion 5a1 and the photoconductive surface, thereby charging the photoconductive surface. In this embodiment, for example, a bias made by overlapping −600 VDC with 2 kVpp (1 kHz) is applied.

In addition, the charging roller 5a according to this embodiment has a very wide margin for the gap between the roller surface of the conductive roller portion 5a1 and the photoconductive surface, so that management of the gap with high precision is unnecessary.

Therefore, as a member for maintaining the gap between the roller surface of the conductive roller portion 5a1 and the photoconductive surface, an elastic member may be interposed between the roller surface of the conductive roller portion 5a1 and the photoconductive surface.

Therefore, in this embodiment, the charging roller in which the flange portion 5a2 formed by resin molding is coated with the insulating elastic layer 5a3 on the surface can be used. Accordingly, deterioration of the photoconductive surface of the photoconductor can be suppressed.

Specifically, it is preferable that the insulating elastic layer 5a3 have a JIS-A hardness of 40 degrees to 70 degrees and have a thickness T1 of 10 μm or higher. Accordingly, deterioration of the photoconductive surface can be significantly suppressed.

Here, rollers in which holes having the same diameter as the shaft are molded as the flange portions 5a2 so as to be disposed at both end portions of the conductive roller portion 5a1 through the core metal (shaft) of the conductive roller portion 5a1, and urethane rubber layers are formed on the surfaces of the rollers.

The roller may be molded of a general-purpose resin. As the rubber layer, an insulating rubber layer having a JIS-A hardness of 40 degrees is formed to be 10 μm. Besides, for example, a urethane foam layer having an ASKER-C hardness of 50 degrees may be employed.

As a result, the charging roller according to this embodiment may have the flange portion 5a2 for maintaining the gap between the roller surface of the conductive roller portion 5a1 and the photoconductive surface, and whether the conductive roller portion 5a1 and the flange portion 5a2 are separate members or are integrated in one body is not restricted.

For example, elastic layers may be formed integrally with both end portions of the conductive roller portion 5a1 to form the flange portion 5a2 and the conductive roller portion 5a1 integrally with each other.

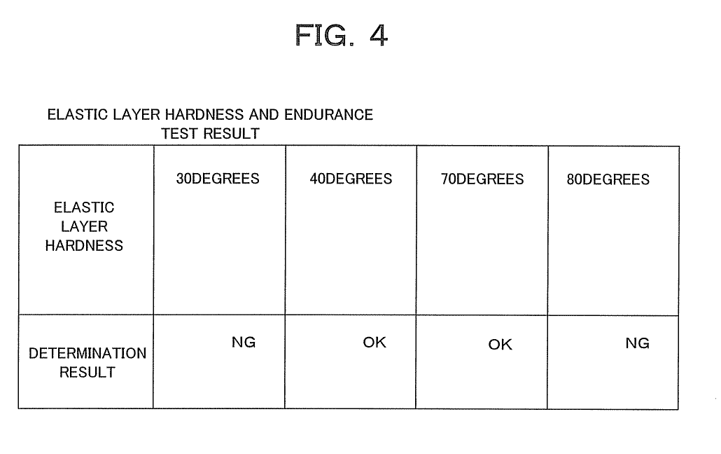

An endurance test that evaluates damage in photoconductors when the charging roller having the configuration shown in FIGS. 2 and 3 was employed and urethane rubber layers having JIS-A hardnesses of 30 degrees, 40 degrees, 70 degrees, and 80 degrees were used as the insulating elastic layer 5a3 was performed. The result is shown in FIG. 4.

The endurance test was conducted by performing a printing operation for about 100,000 sheets and determining the image evaluation result thereof. When there is significant photoconductor damage, many carrier flaws and holes are present on the surface of the photoconductor, and filming generation problems or defects such as streaks in the image occur.

As the test result, when the insulating elastic layer having the JIS-A hardness of 30 degrees was employed, the elastic layer itself had insufficient durability, and damage in the photoconductive surface could not be suppressed.

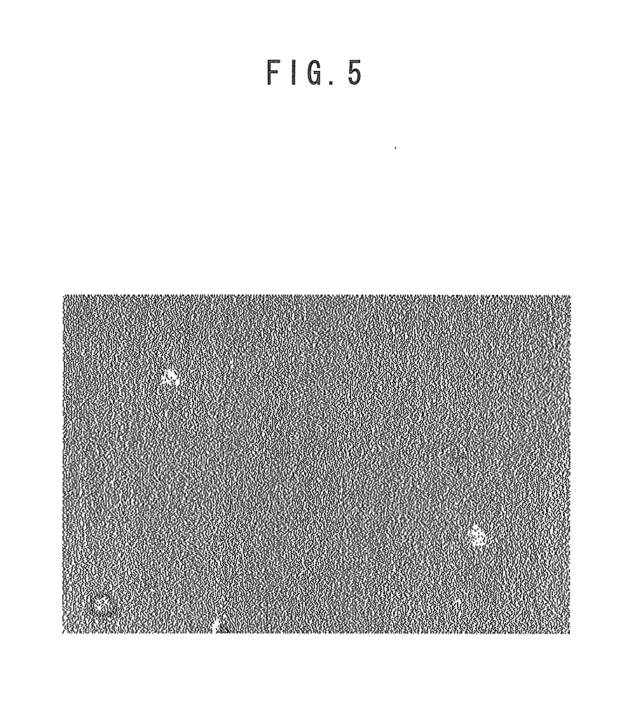

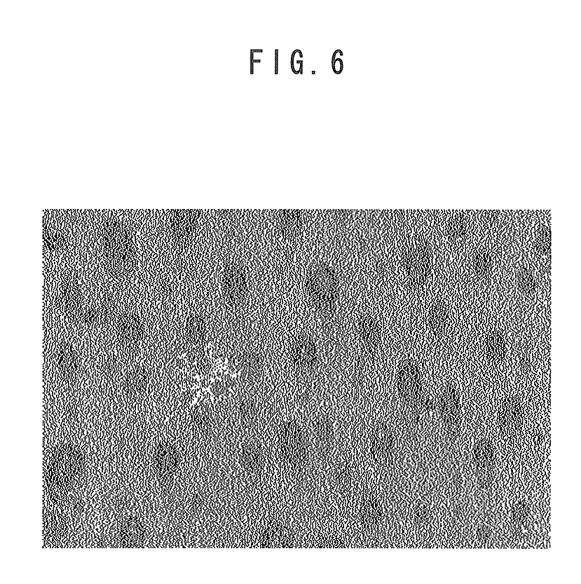

FIG. 5 is a surface enlarged photograph showing a photoconductive surface of a photoconductor which is not damaged (OK), and FIG. 6 is a surface enlarged photograph showing a deteriorated photoconductive surface where carrier flaws or holes are present (NG).

### Modified Example

Next, a modified example will be described.

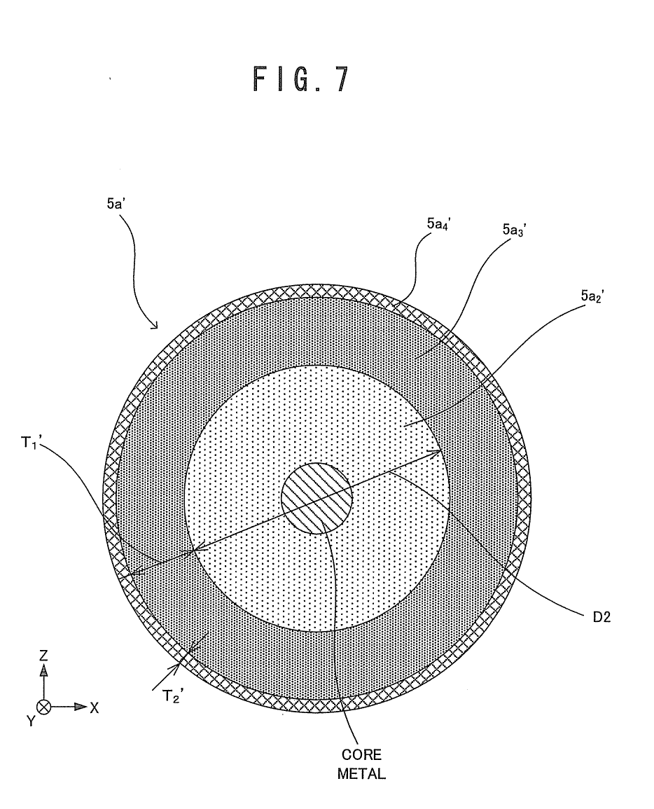

FIG. 7 is a diagram showing the cross-section of a charging roller 5a′ related to the modified example. In the example shown in FIG. 7, a fluorine surface layer 5a4′ is further coated on the surface layer of an insulating elastic layer 5a3′.

In this modified example, for the purpose of preventing wear due to the photoconductor and preventing toner adhesion, a fluorine surface layer 5a4′ having a thickness of about 3 to 5 μm is formed.

An evaluation test was conducted using the charging roller 5a′ having the configuration shown in FIG. 7.

In the evaluation test, the thickness T2′ of the fluorine surface layer 5a4′ was set to 3 μm, 4 μm, and 5 μm.

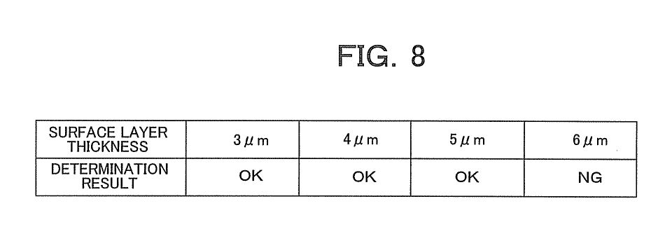

FIG. 8 is a table showing the test result of an endurance test when the thickness of the fluorine surface layer 5a4′ was changed.

As seen from the test result shown in FIG. 8, when the thickness T2′ of the fluorine surface layer 5a4′ is too high (6 μm or higher), a cushioning effect by the insulating elastic layer 5a3′ is damaged, and the damage in the photoconductor becomes significant, such that image defects are visible.

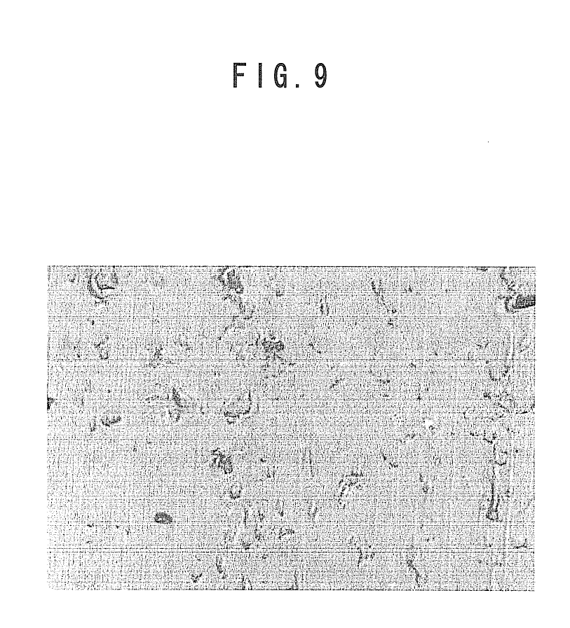

FIG. 9 is an enlarged photograph of the surface of the photoconductor under a condition in which no problem is determined when the evaluation test is performed using the charging roller 5a′ having the configuration shown in FIG. 7. As shown in FIG. 9, in the configuration in which the fluorine surface layer 5a4′ is further formed on the surface layer of the insulating elastic layer 5a3′, slight damage is shown on the photoconductive surface, but it can be understood that the damage is not at a level that has an effect on image quality.

As such, a level required to maintain the precision for maintaining the gap is moderated by using the charging roller made of a material having a wide gap margin, so that flaws in the surface of the photoconductor can be suppressed using an elastic body for at least a part of the member for maintaining the gap.

In addition, by employing such configurations, deterioration of the photoconductor due to carrier incorporation can also be suppressed.

As described above in detail, according to the technique described in the specification, a technique capable of suppressing deterioration of the surface layer of the photoconductor while maintaining the gap between the charging roller and the photoconductor with high precision in a non-contact charge can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a photoconductor that rotates about a first rotation axis; and
a charging roller that rotates about a second rotation axis which is parallel to the first rotation axis,
wherein the charging roller includes
a conductive roller portion that extends in parallel with the first rotation axis and contains an ion-conductive agent,
a flange portion that is provided on an outer peripheral surface of the conductive roller portion further to the outside than an image forming area of the photoconductor in the second rotation axis direction so as to protrude outward from the outer peripheral surface in a radial direction of the conductive roller portion into a flange shape, and
an insulating elastic layer that coats an outer peripheral surface of the flange portion and has an elasticity higher than that of a photoconductive surface of the photoconductor.

2. The apparatus according to claim 1, wherein the flange portions are provided at both ends of the conductive roller portion in the second rotation axis direction.

3. The apparatus according to claim 1, wherein the flange portion has a diameter greater than that of the conductive roller portion.

4. The apparatus according to claim 1, wherein the insulating elastic layer is an insulating rubber layer.

5. The apparatus according to claim 1, wherein an average gap between the photoconductive surface of the photoconductor and a roller surface of the conductive roller portion is equal to or greater than 50 μm and equal to or smaller than 300 μm.

6. The apparatus according to claim 1, wherein the insulating elastic layer is an insulating rubber layer having a thickness of equal to or greater than 10 μm and a JIS-A hardness in the range of 40 degrees to 70 degrees.

7. The apparatus according to claim 1, wherein an outer peripheral surface of the insulating elastic layer is coated with a fluorine surface layer having a thickness of equal to or greater than 3 μm and equal to or smaller than 5 μm.

8. The apparatus according to claim 1, wherein an average gap between the photoconductive surface of the photoconductor and a roller surface of the conductive roller portion is greater than an average particle diameter of carrier particles contained in a two-component developer which forms an image on the photoconductive surface of the photoconductor.

9. A gap maintaining method of a charging roller in an image forming apparatus which includes a photoconductor that rotates about a first rotation axis and a charging roller that rotates about a second rotation axis which is parallel to the first rotation axis, the method comprising:
maintaining a gap between an outer peripheral surface of a conductive roller portion and a photoconductive surface of the photoconductor, by a flange portion provided on the outer peripheral surface of the conductive roller portion that extends in parallel with the first rotation axis and contains anion-conductive agent further to the outside than an image forming area of the photoconductor in the second rotation axis direction so as to protrude outward from the outer peripheral surface in a radial direction of the conductive roller portion into a flange shape, and an insulating elastic layer that coats an outer peripheral surface of the flange portion and has an elasticity higher than that of the photoconductive surface of the photoconductor.

10. The method according to claim 9, wherein the flange portions are provided at both ends of the conductive roller portion in the second rotation axis direction.

11. The method according to claim 9, wherein the flange portion has a diameter greater than that of the conductive roller portion.

12. The method according to claim 9, wherein the insulating elastic layer is an insulating rubber layer.

13. The method according to claim 9, wherein an average gap between the photoconductive surface of the photoconductor and a roller surface of the conductive roller portion is equal to or greater than 50 μm and equal to or smaller than 300 μm.

14. The method according to claim 9, wherein the insulating elastic layer is an insulating rubber layer having a thickness of equal to or greater than 10 μm and a JIS-A hardness in the range of 40 degrees to 70 degrees.

15. The method according to claim 9, wherein an outer peripheral surface of the insulating elastic layer is coated with a fluorine surface layer having a thickness of equal to or greater than 3 μm and equal to or smaller than 5 μm.

16. The method according to claim 9, wherein an average gap between the photoconductive surface of the photoconductor and a roller surface of the conductive roller portion is greater than an average particle diameter of carrier particles contained in a two-component developer which forms an image on the photoconductive surface of the photoconductor.
